(19) United States
(12) Patent Application Publication
(10) Pub. No.: US 2026/0230863 A1
(43) Pub. Date: Aug. 6, 2026

(54) SIGNALING JITTER STATISTICS INFORMATION

(71) Applicant: Telefonaktiebolaget LM Ericsson (publ), Stockholm (SE)

(72) Inventors: Paul SCHLIWA-BERTLING, Ljungsbro (SE); Andra Mihaela VOICU, Aachen (DE); Mohammed Yazid LYAZIDI, London (GB)

(73) Assignee: Telefonaktiebolaget LM Ericsson (publ), Stockholm (SE)

(21) Appl. No.: 19/128,647

(22) PCT Filed: Nov. 10, 2023
(86) PCT No.: PCT/IB2023/061386

§ 371 Date: May 9, 2025

Related U.S. Application Data
(60) Provisional application No. 63/424,444, filed on Nov. 10, 2022.

(51) Int. Cl. H04W 24/08

(52) U.S. Cl. CPC H04W 24/08

(57) ABSTRACT

A method performed by a network node. The method includes obtaining jitter information, JI (the JI may comprise jitter range information indicating a jitter range). The method also includes transmitting to a node of an access network a message comprising time sensitive communication, TSC, assistance information, wherein the TSC assistance information comprises: periodicity information and the JI.

### TECHNICAL FIELD

Disclosed are embodiments related to the signaling of jitter statistics information.

### BACKGROUND

### Extended Reality (XR) Traffic Characteristic

XR applications (e.g., virtual reality (VR) applications, augmented reality (AR) applications, mixed reality (MR) applications) typically generate a data traffic flow which is, in principle, periodic (e.g., video traffic with 30, 60, 90, or 120 fps). However, the traffic arrival moment at a network node (e.g., a base station of a radio access network (RAN)) is affected by jitter around the periodicity value, due to processing of the data (frames) at the application (e.g. for compression) and the capabilities of the platform used by the application, as well as transmission through a network (e.g., a 3GPP core network). This is modelled in reference [4], by assuming that each data frame arriving at the RAN has a random jitter of [−4; +4] milliseconds (ms) (optionally [−5; +5] ms) around the main periodicity. The probability of the jitter value within this interval is given by a truncated Gaussian distribution with mean 0 ms and standard deviation 2 ms.

XR traffic has strict delay requirements, in terms of packet delay budget (PDB). This is the maximum tolerable delay for a packet to be transmitted from a base station (e.g., a 5G base station (gNB)) to a user equipment (UE). The PDB value depends on the XR traffic type and is overall between 5 ms and 30 ms (see reference [4]).

### Time Sensitive Communication (TSC) Assistance Information (TSCAI)

TSC Assistance Information (TSCAI) is a 5G system feature that describe TSC flow traffic characteristics at the gNB ingress and UE egress interface for traffic in downlink and uplink directions. TSCAI may be used by the 5G Access Network (5G-AN), if provided by the Session Management Function (SMF).

Current TSCAI contains the following parameters seen in Tabl below (see also reference [2]).

TABLE 1
TSCAI

| Assistance | |
|---|---|
| Information | Description |
| Flow Direction | The direction of the TSC flow (uplink or downlink). |
| Periodicity | It refers to the time period between start of two |
| | data bursts. |
| Burst Arrival Time | The latest possible time when the first packet of |
| (optional) | the data burst arrives at either the ingress of the |
| | RAN (downlink flow direction) or the egress |
| | interface of the UE (uplink flow direction). |
| Survival Time | Survival Time, as defined in TS 22.261, is |
| (optional) | synonymous with the time period an application |
| | can survive without any data burst. |

The information contained in the TSCAI originates from the Application Function (AF). The information is propagated via the Network Exposure Function (NEF) towards the Time Sensitive Communication and Time Synchronization Function (TSCTSF). Based on the information provided the TSCTSF constructs the TSC Assistance Container (TSCAC) defined below in Tabl:

TABLE 2
TSCAC

| Assistance | |
|---|---|
| Information | Description |
| Flow Direction | The direction of the TSC flow (uplink or downlink). |
| Periodicity | It refers to the time period between start of two |
| | data bursts. |
| Burst Arrival | The time when the first packet of the data burst arrives |
| Time | at the ingress port of 5GS for a given flow direction |
| (optional) | (DS-TT for uplink, NW-TT for downlink). |
| Survival Time | It refers to the time period an application can survive |
| (optional) | without any data burst, as defined in clause |
| | C.2.3 of TS 22.104. |
| Time Domain | The (g)PTP domain of the TSC flow. |
| (optional) | |

The TSCAC is sent to the SMF. The SMF generates the TSCAI from the TSCAC. If the UPF is also connected to an external clock, the SMF can potentially adjust the Information Element(s) (IE) inside the TSCAC when generating the TSCAI to account for clock drift. The TSCAI is then sent from the SMF via Access & Mobility Management Function (AMF) to the 5G-AN using the Next Generation Application Protocol (NGAP). The TSCAI is associated with a single TSC QoS flow.

### SUMMARY

Certain challenges presently exist. For instance, in the context of XR and media services, IP traffic is inherently periodic, but also suffers from jitter. To assist the RAN in configuring UE power saving features, traffic jitter statistics information has to be known per application flow and signaled to the RAN.

Accordingly, in one aspect there is provided a method that includes a network node (control plane node or user plane node) obtaining jitter information (JI) (the JI may comprise jitter range information indicating a jitter range). The method also includes the network node transmitting to a node of an access network a message comprising time sensitive communication (TSC) assistance information. The TSC assistance information comprises periodicity information and the JI.

In another aspect there is provided a method that includes a node of an access network receiving a message comprising time sensitive communication (TSC) assistance information associated with a UE. The TSC assistance information comprises periodicity information and jitter information (e.g., jitter range information). The method also includes using the JI to configure a power saving feature for the UE.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an apparatus (e.g., network node) that is configured to perform the methods disclosed herein. The apparatus may include memory and processing circuitry coupled to the memory.

An advantage of embodiments disclosed herein is that they provide to the RAN not only jitter statistics, but also information about the origin of the jitter statistics. This feature enables the RAN to use this information to decide how to configure a power savings feature for the UE for optimal delay/UE power consumption tradeoffs. For instance, the RAN can use the information to configure the value of the DRX onDurationTimer (the number of subframes over which the UE shall read PDCCH during every DRX cycle before entering the power saving mode (DRX OFF)). For example, if the jitter range stems from the application generating and/or consuming the data traffic, this includes only application jitter, without additional jitter from the CN. Thus, the RAN can decide to set an onDurationTimer value longer than the signaled jitter range by a certain margin, to take into account unknown additional jitter caused by the CN. As another example, if the jitter range was derived by the CN, this jitter range includes both application and CN jitter. Thus, this jitter range is closer to the jitter at RAN, so the onDurationTimer value can be set in a more conservative way, namely approximately the same as the jitter range. Another advantage is that the embodiment enable the CN to maintain historical information on the user of the jitter statistics and can use this historical information to produce a better estimate of the jitter statistics for the next time a UE uses the same services.

### BRIEF DESCRIPTION OF THE DRAWINGS

The accompanying drawings, which are incorporated herein and form part of the specification, illustrate various embodiments.

FIG. 1 illustrates the user plane interfaces for the NG-U.

FIG. 2 illustrates the user plane interfaces for the NG-U.

FIG. 3 depicts the architecture for separation of gNB-CU-CP and gNB-CU-UP.

FIG. 4 illustrates a control plane function providing to RAN node a message comprising jitter statistics information.

FIG. 5 illustrates a user plane function providing to RAN node a message comprising jitter statistics information.

FIG. 6 is a flowchart illustrating a process according to an embodiment.

FIG. 7 is a flowchart illustrating a process according to an embodiment.

FIG. 8 is a block diagram of a network node according to an embodiment.

FIG. 9 is a block diagram of a base station according to an embodiment.

### DETAILED DESCRIPTION

User Plane interfaces

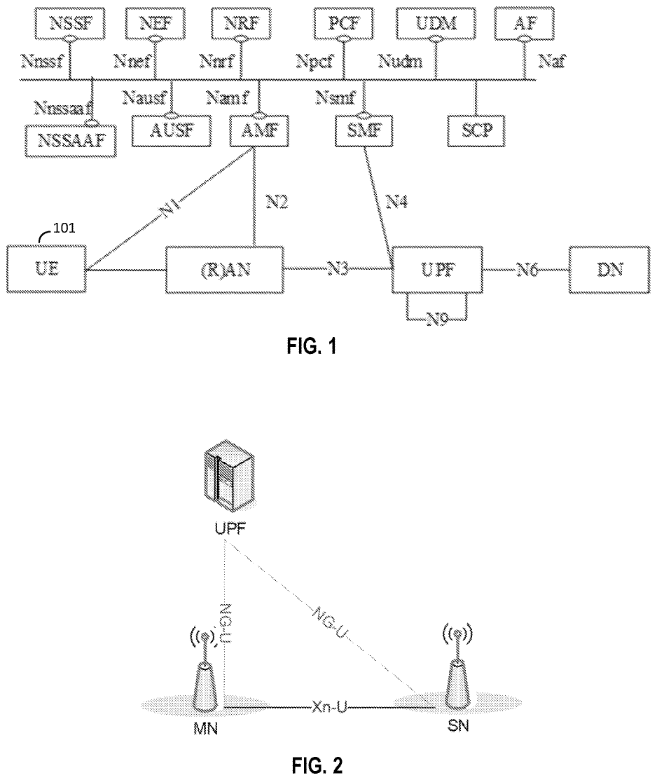

FIG. 1 and FIG. 2 illustrate the user plane interfaces for the NG-U sometimes referred to as the N3 interface between the UPF and the NG-RAN as well as the Xn-U between two NG-RAN nodes are depicted.

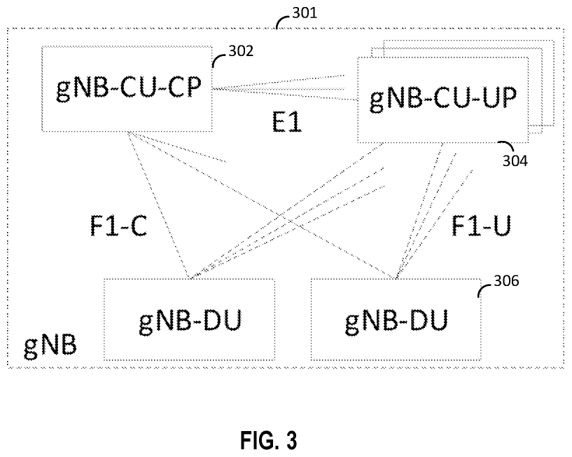

FIG. 3 depicts the overall architecture a gNB 301 having separation of gNB-CU-CP 302 and gNB-CU-UP 304. The gNB-CU-UP is connected to at least one gNB-DU 306 of gNB 301 through the F1-U interface. It shall be noted that GTP-Uv1 as specified in 3GPP TS 29.281 v17.1.0 (“TS 29.281”) is used on the N3/NG-U interface between the UPF and the NG-RAN/CU-UP as well as on the F1-U interface between the CU-UP and the DU and the CU-UPs configured with different NG-RAN/gNBs where Xn-U is established. However, the details on the content of the GTP-U headers is specified in TS 38.415 v16.6.0 (“TS 38.415”) for the NG-U/N3 and the TS 38.425 v16.3.0 (“TS 38.425”) is applicable for the F1-U and XN-U interface.

In reference [5] it was proposed to extend TSCAI to include jitter statistics information for each flow. Currently, 3GPP SA2 is discussing in the context of reference [Error! Reference source not found.] whether the jitter statistics information originates from the application, or is being derived by CN.

Accordingly, we assume here that jitter statistics information either originates from the application, or can be derived by the CN. The CN sends this jitter statistics information to a RAN. The RAN can use the jitter statistics information to optimize UE power saving configurations. For XR traffic, it is important that a UE (e.g., UE 101 shown in FIG. 1) saves energy and at the same time the delay is limited. To this end, the jitter statistics information (a.k.a., jitter statistics or jitter information) (e.g., jitter range (or min/max)) can be used by the RAN to configure the value of the onDurationTimer for the MAC DRX mechanism. In principle, the onDuration Timer should cover the jitter range observed by RAN, so that the UE is awake whenever traffic is expected and sleeps in the rest of the time. Otherwise, either the traffic delay is potentially longer than that tolerated by XR applications (if UE is not awake when traffic arrives), or UE energy is wasted (if the onDurationTimer value is too long).

Depending on where the jitter statistics originate from (either from application or derived by CN), the jitter range statistics are a tighter or looser approximate of the jitter range at the RAN. Thus, if the RAN receives jitter statics information from CN but does not know its origin, it may configure an either too short or too long onDurationTimer value.

Accordingly, this disclosure includes new information in the TSCAI (control plane (CP)) and in-band (user plane (UP)) about the jitter statistics. This jitter statistics information refers to the jitter statistics, and whether they originate from application or are derived by CN.

Control Plane (CP) signaling:

In one embodiment, this disclosure provides signaling methods for indicating jitter statistics information in NG-C interface to let the NG-RAN be aware of that information or its change for radio resource allocation and early RAN traffic control.

User Plane (UP) signaling:

In one embodiment, this disclosure provides signaling methods for indicating the jitter statistics information in the GTP-U extension header to let NG-RAN be aware of that information or its change for radio resource allocation and early RAN traffic control during downlink (DL) signaling.

In some embodiments, the feedback related to jitter statistics is signaled, e.g. in the UP to CN.

As noted above, this disclosure allows the signaling of the jitter statistics over TSCAI and in-band for both DL and UL.

Information about the origin of jitter statistics via CP signaling

In one embodiment, a new attribute (here denoted ‘JitterStatisticsOrigin’) is added to the TSCAI and TSCAC. This attribute can be a value, or a list of values, where each value corresponds to a different entry for jitter statistics information within the same QoS flow.

Alternatively, the new attribute can be a flag, or a list of flags, where each value corresponds to a different entry for jitter statistics information within the same QoS flow. For example, the value ‘1’ can indicate that the jitter statistics information originates from AF, while ‘O’ can indicate that the jitter statistics origination from an application. Alternatively, the interpretation of ‘0’ and ‘1’ can be swapped.

CP signaling of Jitter Statistics Information:

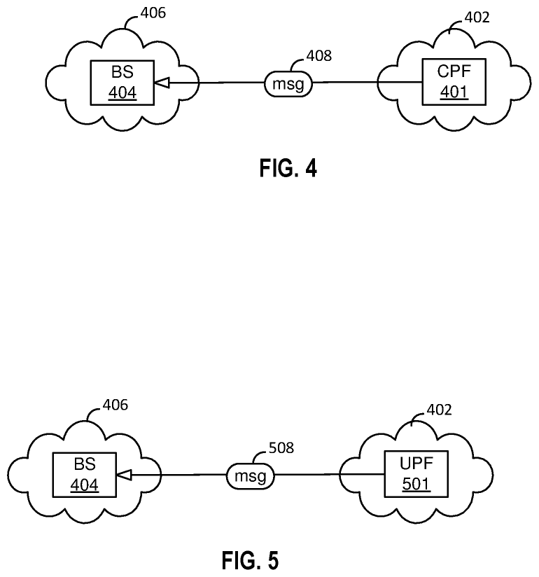

FIG. 4 illustrates an embodiment in which a CP function (CPF) 401 within a CN 402 (e.g., the AMF, the SMF, the TSCTFS) signals jitter statistics information (JSI) (or “jitter information (JI)” for short) to a network node 404 (e.g., gNB 301 or a component of gNB 301, such as, for example CU 302 or CU 304 of the gNB) of NG-RAN 406 via a message (msg) 408 (e.g., an NG-AP message).

In one embodiment, the message 408 includes TSCAI periodicity information associated with the jitter statistics information (JSI) and information indicating the origin of the JSI. For example, the NG-AP message may comprises an information element (e.g., a “TSC Assistance Information” IE) that comprises i) periodicity information (e.g., a Periodicity IE that contains information indicating the time period between start of two data bursts) and ii) the JSI (e.g., an JSI IE that comprises the JSI and optionally origin information indicating an origin of the JSI). In one embodiment, the origin information indicates whether the origin is an AF or derived by a CN CP function. In one embodiment the indication of the origin (i.e., the origin information) can be encoded as an Enumerated IE or as a flag 0/1, where e.g. 0=from AF and 1=derived in CN.

In another embodiment, the JSI and origin information is signaled via an existing NG-AP procedure from CN to NG-RAN. This can be part of e.g. the Packet Data Unit (PDU) Session Management Messages defined in section 9.2.1 of 3GPP TS 38.413 v17.2.0 (“TS 38.413”) (such as, for example, the PDU Session Resource Setup/Modify Request).

In one alternative embodiment to the above embodiment, a new procedure, e.g., a class 2 NG-AP “Traffic Parameters Control” message is defined to introduce or update the jitter statistics from CN to NG-RAN Node.

Without loss of generality, below are non-limiting example of signaling the JSI and origin information by extending existing CP signaling defined in 3GPP TS 38.413

### TSC Traffic Characteristics IE

The TSC Traffic Characteristics IE provides the traffic characteristics of TSC QoS flows. Table 3 below illustrates the TSC Traffic Characteristics IE according to an embodiment. As shown in Table 3, the IE may include downlink (DL) TSC assistance information (i.e., a TSC Assistance Information IE containing DL assistance information) and/or uplink (UL) TSC assistance information (i.e., a separate TSC Assistance Information IE containing UL assistance information)

TABLE 3
TSC Traffic Characteristics IE

| | | | | |
|---|---|---|---|---|
| | | | IE type and | Semantics |
| IE/Group Name | Presence | Range | reference | description |

| | | |
|---|---|---|
| TSC Assistance | O | TSC Assistance |
| Information | | Information |
| Downlink | | |
| TSC Assistance | O | TSC Assistance |
| Information | | Information |
| Uplink | | |

### TSC Assistance Information IE

The TSC Assistance Information IE provides the TSC assistance information for a TSC QoS flow in the uplink or downlink (see 3GPP TS 23.501 v17.6.0 (“TS 23.501”)). Table 4 illustrates an embodiment of the TSC Assistance Information IE. The embodiment illustrated in Table 4 is nearly identical to the TSC Assistance Information IE defined in TS 38.413, with the exception that the TSC Assistance Information IE according to the embodiment shown in FIG. 4 includes an additional IE named “Jitter Statistics Information.”

TABLE 4
TSC Assistance Information IE

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Periodicity | M | 9.3.1.132 | — | |
| Burst Arrival Time | O | 9.3.1.133 | — | |
| Survival Time | O | 9.3.1.221 | YES | ignore |
| Jitter Statistics | O | 9.3.1.X | YES | ignore |
| Information | | | | |

### 9.3.1.X Jitter Statistics Information (JSI) IE

Table 5 illustrates an embodiment of the JSI IE. In the embodiment shown, the JSI IE provides JSI (e.g., jitter range information, max value, min value) and origin information indicating the origin of the JSI.

TABLE 5
JSI IE

| | | | | |
|---|---|---|---|---|
| IE/Group | | | IE type and | Semantics |
| Name | Presence | Range | reference | description |

| | | |
|---|---|---|
| Jitter range | M | INTEGER(FFS) |
| Maximum value | O | INTEGER(FFS) |
| Minimum value | O | INTEGER(FFS) |
| Origin | O | ENUMERATED |
| | | (CN, AF, . . .) |

In another embodiment, the NG-RAN can inform of the endorsed jitter statistics values to CN either via an existing NGAP procedure, PDU SESSION SETUP RESPONSE, or over a new NGAP class 2 “Traffic Parameters Feedback” message. Alternatively, the interaction between CN and NG-RAN over NG-C can be achieved via any class 1 request/response procedure.

### UP Signaling of JSI:

FIG. 5 illustrates an embodiment in which a UP node (e.g., UPF) 501 signals jitter statistics information (JSI) to a network node 404 (e.g., gNB 301 or component thereof) of NG-RAN 406 via a message 508 (e.g., a GTP message).

GTP-Uv1, as specified in 3GPP TS 29.281 v17.1.0 (“TS 29.281”), is used on the N3/NG-U interface between the UPF and the NG-RAN/CU-UP as well as on the F1-U interface between the CU-UP and the DU and the CU-UPs configured with different NG-RAN/gNBs where Xn-U is established. However, the details on the content of the GTP-U headers is specified in 3GPP TS 38.415 v16.6.0 (“TS 38.415”) for the NG-U/N3 and the 3GPP TS 38.425 v16.3.0 (“TS 38.425”) is applicable for the F1-U and XN-U interface.

In one embodiment, one or more fields are added to the GTP header for providing JSI as in-band information.

Using the DL PDU SESSION INFORMATION in TS 38.415, one example, without loss of generality is shown below in table 6. Table 6 shows the DL PDU SESSION INFORMATION frame according to one embodiment. This frame format is defined to allow the NG-RAN to receive some control information elements which are associated with the transfer of a packet over the interface.

TABLE 6
DL PDU SESSION INFORMATION Frame Format

| Bits | | | | | | | | Number of |
|---|---|---|---|---|---|---|---|---|
| 7 | 6 | 5 | 4 | 3 | 2 | 1 | 0 | Octets |

| | | | | |
|---|---|---|---|---|
| PDU Type (=0) | QMP | SNP | Spare | 1 |

| | | | |
|---|---|---|---|
| PPP | RQI | QoS Flow Identifier | 1 |

| PPI | Jitter | Spare | 0 or 1 |
|---|---|---|---|
| | Statistics | | |
| | Origin | | |

| | |
|---|---|
| DL Sending Time Stamp | 0 or 8 |
| DL QFI Sequence Number | 0 or 3 |
| Traffic Flow Identifier | 0 or 4 |
| Traffic Jitter range | 0 or 4 |
| Traffic Jitter min | 0 or 4 |
| Traffic Jitter max | 0 or 4 |
| Padding | 0-3 |

In another embodiment, the DL USER DATA frame in TS 38.425 is extended as shown in Table 7 below to carrier the JSI and origin information.

TABLE 7

| Bits | | | | | | | | Number of |
|---|---|---|---|---|---|---|---|---|
| 7 | 6 | 5 | 4 | 3 | 2 | 1 | 0 | Octets |

| PDU Type (=0) | | Spare | DL | DL | Report | 1 |
|---|---|---|---|---|---|---|
| | | | Discard | Flush | polling | |
| | | | Blocks | | | |
| Spare | Request | Report | User | Assistance | Retransmission | 1 |
| | OutofSeq | Delivered | data | Info | flag | |
| | Report | | existence | Report | | |
| | | | flag | Polling | | |
| | | | | Flag | | |

| | |
|---|---|
| NR-U Sequence Number | 3 |
| DL discard NR PDCP PDU SN | 0 or 3 |
| DL discard Number of blocks | 0 or 1 |
| DL discard NR PDCP PDU SN start (first block) | 0 or 3 |
| Discarded Block size (first block) | 0 or 1 |
| . . . | |
| DL discard NR PDCP PDU SN start (last block) | 0 or 3 |
| Discarded Block size (last block) | 0 or 1 |
| DL report NR PDCP PDU SN | 0 or 3 |
| Padding | 0-3 |
| Jitter statistic origin | 0 or 4 |
| Traffic Jitter range | 0 or 4 |
| Traffic Jitter min | 0 or 4 |
| Traffic Jitter max | 0 or 4 |

In another embodiment, the DL DATA DELIVERY STATUS (PDU Type 1) Format frame in TS 38.425 is extended as shown in Table 8 below to carrier the JSI and origin information.

TABLE 8

| Bits | | | | | | | | # |
|---|---|---|---|---|---|---|---|---|
| 7 | 6 | 5 | 4 | 3 | 2 | 1 | 0 | Octets |

| PDU Type (=1) | | Highest | Highest | Final | Lost | 1 |
|---|---|---|---|---|---|---|
| | | Transmitted | Delivered | Frame | Packet | |
| | | NR | NR | Ind. | Report | |
| | | PDCP | PDCP | | | |
| | | SN Ind | SN Ind | | | |
| Spare | Delivered | Data | Retransmitted | Delivered | Cause | 1 |
| | NR | rate | NR | Retransmitted | Report | |
| | PDCP | Ind. | PDCP | NR | | |
| | SN | | SN Ind | PDCP | | |
| | Range | | | SN Ind | | |
| | Ind | | | | | |

| | |
|---|---|
| Desired buffer size for the data radio bearer | 4 |
| Desired Data Rate | 0 or 4 |
| Number of lost NR-U Sequence Number ranges reported | 0 or 1 |
| Start of lost NR-U Sequence Number range | 0 or (6* Number |
| End of lost NR-U Sequence Number range | of reported lost |
| | NR-U SN |
| | ranges) |
| Highest successfully delivered NR PDCP Sequence Number | 0 or 3 |
| Highest transmitted NR PDCP Sequence Number | 0 or 3 |
| Cause Value | 0 or 1 |
| Successfully delivered retransmitted NR PDCP Sequence Number | 0 or 3 |
| Retransmitted NR PDCP Sequence Number | 0 or 3 |
| Number of successfully delivered out of sequence PDCP | 0 or 1 |
| Sequence Number range | |
| Start of successfully delivered out of sequence PDCP | 0 or (6* Number |
| Sequence Number range | of successfully |
| End of successfully delivered out of sequence PDCP | delivered out of |
| Sequence Number range | sequence PDCP |
| | Sequence |
| | Number range) |
| Padding | 0-3 |
| Jitter statistic origin | 0 or 4 |
| Traffic Jitter range | 0 or 4 |
| Traffic Jitter min | 0 or 4 |
| Traffic Jitter max | 0 or 4 |

The follow description applies to each one of the three above examples. The Jitter Statistics Origin parameter indicates the origin of the Jitter statistics information included in the frame (i.e., the Traffic Jitter range, min, and max values). In one the Jitter Statistics Origin parameter has a length of 1 bit and a value of 0 indicates that the origin is the AF and a value of 1 indicates that the origin is a CN function (i.e., Value range: {0=AF, 1=CN}). The Traffic Flow Identifier parameter, when present, indicates the Traffic Flow Identifier of the flow associated to the jitter statistics information. The value range is: {0 . . . 28-1} and the length of this field is 8 bits (hence the value range of 0 to 28-1. The Traffic Jitter range parameter indicates the jitter range for traffic flow. The value range is: {0 . . . 2ⁿ-1} and the field length of m octets. The Traffic Jitter minimum parameter indicates the minimum jitter value for the identified traffic flow. The value range is: {0 . . . 2ⁿ−1} and the field length is m octets. The traffic Jitter maximum parameter indicates the maximum jitter value for the traffic flow. The value range is: {0 . . . 2ⁿ−1} and the field length is m octets.

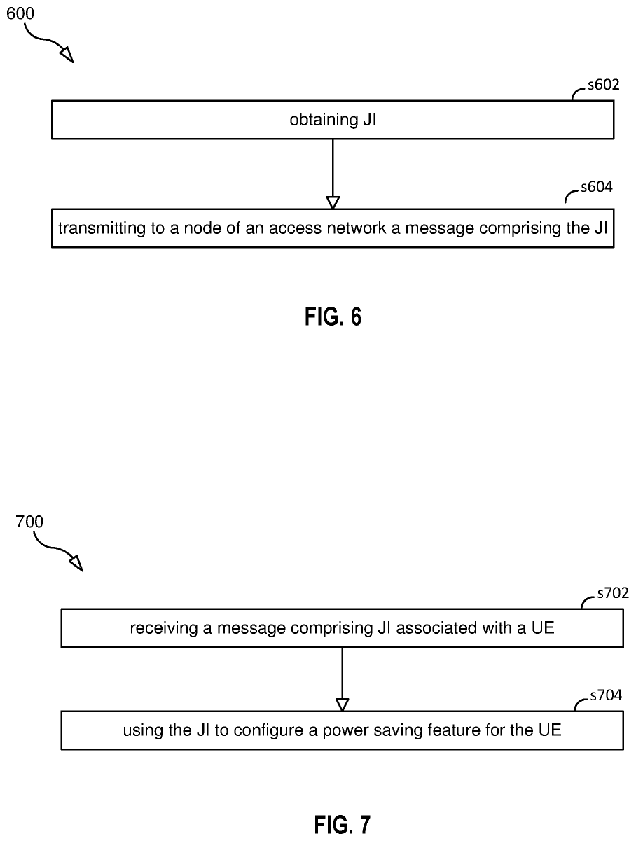

FIG. 6 is a flow chart illustrating a process 600, according to an embodiment, for providing jitter statistics information (or “jitter information (JI)” for short). Process 600 may begin in step s602.

Step s602 comprises a network node (control plane node 401 or user plane node 501) obtaining JI. In one embodiment, the JI comprise jitter range information indicating a jitter range.

Step s604 comprises the network node transmitting to a node of an access network (e.g., base station 404 or CU of the base station) a message comprising the JI (e.g., control plane msg 408 or user plane msg 508). In one embodiment, the message comprises TSC assistance information, wherein the TSC assistance information comprises periodicity information and the JI (e.g., the jitter range information).

In one embodiment, the periodicity information indicates a time period between a start of two data bursts.

In one embodiment, the message is session management message.

In one embodiment, the session management message requests the node of the access network to assign PDU resources.

In one embodiment, wherein the network node comprises a session management function, SMF.

In one embodiment, wherein the network node comprises or consists of a control unit (CU) (e.g., a CU of a gNB, such as, a gNB-CU-CP or gNB-CU-UP) and the node of the access network comprises or consists of a distributed unit (DU) (e.g., a DU of the gNB).

In one embodiment, the JI included in the message further comprises origin information indicating an origin of the JI. In one embodiment, the origin information is a single bit. In one embodiment, when the bit is set to a first value, the origin information indicates that the origin of the JI is an application function, and when the bit is set to a second value, the origin information indicates that the origin of the JI is a core network function.

In one embodiment, the message comprising the JI is a control plane message, such as, for example, an F1 interface message or an Xn interface message or other control plane message.

FIG. 7 is a flow chart illustrating a process 700, according to an embodiment. Process 700 may begin in step s702.

Step s702 comprises a node of an access network receiving a message (e.g., control plane msg 408 or user plane msg 508) comprising JI associated with a UE. In one embodiment, the JI includes jitter range information. In one embodiment, the message comprises TSC assistance information, wherein the TSC assistance information comprises periodicity information and the JI (e.g., jitter range information).

Step s704 comprises the node using the JI to configure a power saving feature for the UE (e.g., configuring a DRX timer, such as duration of ‘ON time’ within one DRX cycle).

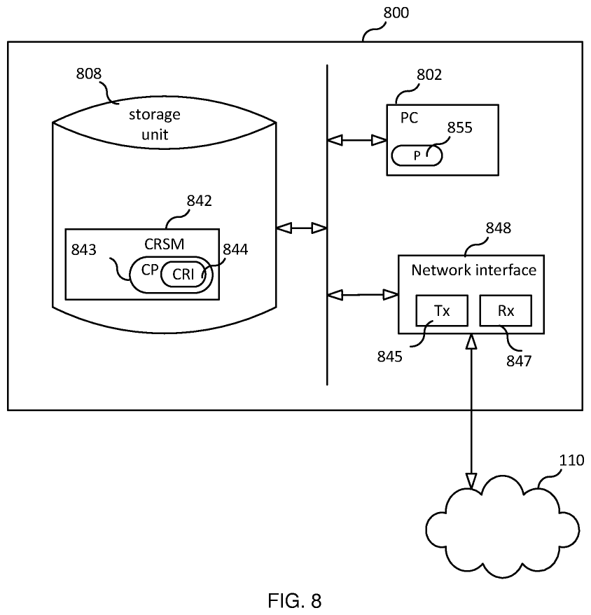

FIG. 8 is a block diagram of a network node 800, according to some embodiments, which can implement CU 302, CU 304, CPF 401, or user plane node 501. As shown in FIG. 8, network node 800 may comprise: processing circuitry (PC) 802, which includes one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., network node 800 may be a distributed computing apparatus); at least one network interface 848 (e.g., a physical interface or air interface) comprising a transmitter (Tx) 845 and a receiver (Rx) 847 for enabling network node 800 to transmit data to and receive data from other nodes connected to a network 110 (e.g., an Internet Protocol (IP) network) to which network interface 848 is connected (physically or wirelessly) (e.g., network interface 848 may be coupled to an antenna arrangement comprising one or more antennas for enabling network node 800 to wirelessly transmit/receive data); and a storage unit (a.k.a., “data storage system”) 808, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes network node 800 to perform steps described herein (e.g., steps described herein with reference to the flow charts). In other embodiments, network node 800 may be configured to perform steps described herein without the need for code. That is, for example, PC 802 may consist merely of one or more ASICs. Hence, the features of the embodiments described herein may be implemented in hardware and/or software.

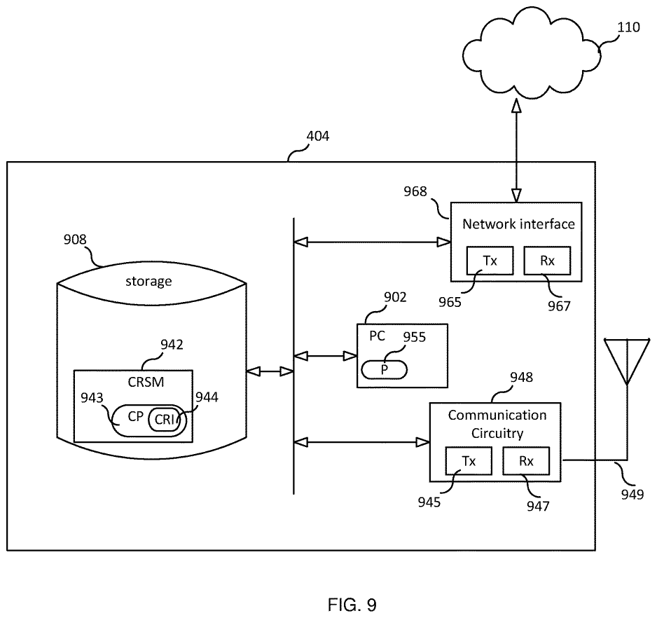

FIG. 9 is a block diagram of network node 404, according to some embodiments. As shown in FIG. 9, network node 404 may comprise: processing circuitry (PC) 902, which includes one or more processors (P) 955 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., base station may be a distributed computing apparatus); a network interface 968 comprising a transmitter (Tx) 965 and a receiver (Rx) 967 for enabling network node 404 to transmit data to and receive data from other nodes connected to a network 110 (e.g., an Internet Protocol (IP) network) to which network interface 968 is connected; communication circuitry 948 (e.g., radio transceiver circuitry comprising an Rx 947 and a Tx 945) coupled to an antenna system 949 for wireless communication with UEs or other nodes; and a storage unit (a.k.a., “data storage system”) 908, which may include one or more non-volatile storage devices and/or one or more volatile storage devices. In embodiments where PC 902 includes a programmable processor, a computer readable storage medium (CRSM) 942 may be provided. CRSM 942 may store a computer program (CP) 943 comprising computer readable instructions (CRI) 944. CRSM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes network node 404 to perform steps described herein (e.g., steps described herein with reference to one or more flow charts). In other embodiments, network node 404 may be configured to perform steps described herein without the need for code. That is, for example, PC 902 may consist merely of one or more ASICs. Hence, the features of the embodiments described herein may be implemented in hardware and/or software.

### Additional Embodiments

A1. A method comprising: a network node (a CU 302, 304, a control plane node 401, or user plane node 501) obtaining JSI; and the network node transmitting to a node of an access network (e.g., base station 404 or DU 306) a message comprising the JSI.

A2. A method comprising: a node of an access network receiving a message comprising JSI associated with a user equipment, UE; and the node using the JSI to configure a power saving feature for the UE (e.g., configuring a DRX timer, such as duration of ‘ON time’ within one DRX cycle).

A3. The method of embodiment A1 or A2, wherein the message further comprising origin information indicating an origin of the JSI.

A4. The method of embodiment A3, wherein the origin information is a single bit.

A5. The method of embodiment A4, wherein when the bit is set to a first value, the origin information indicates that the origin of the JSI is an application function, and when the bit is set to a second value, the origin information indicates that the origin of the JSI is an core network function.

A6. The method of any one of embodiments A1-A5, wherein the message is a control plane message.

A7. The method of any one of embodiments A1-A6, wherein the message is a user plane message.

B1. A computer program (843) comprising instructions (844) which when executed by processing circuitry (802) of a network node causes the network node to perform the method of any one of A1 or A3-A7.

B2. A computer program (943) comprising instructions (944) which when executed by processing circuitry (902) of a node of an access network causes the node to perform the method of any one of A2-A7.

B3. A carrier containing the computer program of embodiment B1 or B2, wherein the carrier is one of an electronic signal, an optical signal, a radio signal, and a computer readable storage medium (842, 942).

C1. A network node, the network node comprising: processing circuitry; and memory containing instructions executable by the processing circuitry for configuring the network node to perform a process comprising: obtaining JSI; and transmitting to a node of an access network (e.g., base station 404) a message comprising the JSI.

C2. The network node of embodiment C1, wherein the network node is configured to perform the method of any one of embodiments A3-A7.

D1. A node for use in an access network, the node comprising: processing circuitry; and memory containing instructions executable by the processing circuitry for configuring the node to perform a process comprising: receiving a message comprising JSI associated with a user equipment, UE; and using the JSI to configure a power saving feature for the UE (e.g., configuring a DRX timer, such as duration of ‘ON time’ within one DRX cycle).

D2. The network node of embodiment D1, wherein the network node is configured to perform the method of any one of embodiments A2-A7.

### CONCLUSION

As detailed above, this disclosure relates to signaling jitter statistics information from the Core Network (CN) to the RAN and also involves signaling as attributes of Time Sensitive Communication Assistance Information (TSCAI). For instance, this disclosure proposes new attributes for jitter statistics in the GTP-U extension header.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] 3GPP TR 23.700-60 v1.2.0, (2022-10) Study on XR (Extended Reality) and media services (Release 18)
[2] 3GPP TS 23.501 v17.6.0 (2022-09), Section 5.27 Enablers for Time Sensitive Communications and Time Synchronization.
[3] 3GPP TS 38.413 v17.2.0 (“TS 38.413”)
[4] 3GPP, TR 38.838 V17.0.0 (2021-12), “Study on XR (Extended Reality) Evaluations for 4R”.
[5] International Patent Publication Number WO2013187014, “TIME SENSITIVE COMMUNICATION ASSISTANCE INFORMATION.”
[6] 3GPP TS 38.415 v17.0.0.
[7] 3GPP TS 38.425 v17.1.0.

1. A method performed by a network node, the method comprising:
obtaining jitter information; JI; and
transmitting to a node of an access network a message comprising time sensitive communication, TSC, assistance information, wherein the TSC assistance information comprises:
periodicity information, and
the JI.

2. The method of claim 1, wherein the periodicity information indicates a time period between a start of two data bursts.

3. (canceled)

4. The method of claim 1, wherein the message requests the node of the access network to assign packet data unit, PDU, resources.

5. The method of claim 1, wherein
the network node comprises a session management function, or
the network node comprises a control unit, and the node of the access network comprises a distributed unit.

6. The method of claim 1, wherein the JI included in the message further comprises origin information indicating an origin of the JI.

7. The method of claim 6, wherein the origin information is a single bit.

8. The method of claim 7, wherein
when the single bit is set to a first value, the origin information indicates that the origin of the JI is an application function, and
when the single bit is set to a second value, the origin information indicates that the origin of the JI is a core network function.

9. The method of claim 1, wherein the message is a control plane message.

10. The method of claim 1, wherein the JI comprises jitter range information indicating a jitter range.

11. A method performed by a node of an access network, the method comprising:
receiving a message comprising time sensitive communication (TSC) assistance information associated with a user equipment wherein the TSC assistance information comprises:
periodicity information, and
jitter information, JI; and
using the JI to configure a power saving feature for the UE.

12. The method of claim 11, wherein the periodicity information indicates a time period between a start of two data bursts.

13. The method of claim 11, wherein the message is a session management message.

14. The method of claim 13, wherein the session management message requests the node of the access network to assign packet data unit, PDU, resources.

15. The method of claim 11, wherein
the message was transmitted by a network node, and
the network node comprises a session management function, SMF, or
the network node comprises a control unit and the node of the access network comprises a distributed unit.

16. The method of claim 11, wherein the JI included in the message further comprises origin information indicating an origin of the JI.

17. (canceled)

18. The method of claim 16, wherein
the origin information is a single bit,
when the single bit is set to a first value, the origin information indicates that the origin of the JI is an application function, and
when the single bit is set to a second value, the origin information indicates that the origin of the JI is a core network function.

19. The method of claim 11, wherein the message is a control plane message.

20. The method of claim 11, wherein the JI comprises jitter range information.

21. A network node, the network node comprising:
processing circuitry; and
memory storing instructions executable by the processing circuitry for configuring the network node to perform a process comprising:
obtaining jitter information, JI, wherein the JI comprises jitter range information indicating a jitter range; and
transmitting to a node of an access network a message comprising time sensitive communication, TSC, assistance information, wherein the TSC assistance information comprises:
periodicity information, and
the JI comprising the jitter range information.

22. (canceled)

23. A node for use in an access network, the node comprising:
processing circuitry; and
memory storing instructions executable by the processing circuitry for configuring the node to perform a process comprising:
receiving a message comprising time sensitive communication, TSC, assistance information associated with a user equipment, UE, wherein the TSC assistance information comprises:
periodicity information, and
jitter information comprising jitter range information; and
using the JSI the JI to configure a power saving feature for the UE.

24. (canceled)
